(19) United States
(12) Patent Application Publication
(10) Pub. No.: US 2013/0284484 A1
(43) Pub. Date: Oct. 31, 2013

(54) PROTECTOR AND WIRING HARNESS

(71) Applicant: Eiichi Toyama, Kosai (JP)

(72) Inventor: Eiichi Toyama, Kosai (JP)

(73) Assignee: YAZAKI CORPORATION, Tokyo (JP)

(21) Appl. No.: 13/979,683

(22) PCT Filed: Jan. 20, 2012
(86) PCT No.: PCT/JP2012/000345

§ 371 Date: Jul. 15, 2013

(30) Foreign Application Priority Data
Jan. 21, 2011 (JP) 2011-010418

(51) Int. Cl. B60R 16/02

(52) U.S. Cl. CPC B60R 16/0215
USPC 174/68.3

(57) ABSTRACT

To provide a protector which does not need an extensive facility or an extensive die, and a wiring harness having the protector. A half pipe working as a protector is made by hardening water-curable resin composition held in base material. The half pipe can be made in a facility for only hardening it having a simplified die, and can be formed and provided in a wiring harness production process, namely, can be formed and provided corresponding to a vehicle requirement. The half pipe includes: a main body portion having a shape of substantially half of a circular pipe; and an attaching portion continued to the main body portion. The main body portion includes a conductive line receiving portion for receiving a high voltage conductive line.

### TECHNICAL FIELD

This invention relates to a protector and a wiring harness having the protector.

### BACKGROUND ART

A wiring harness is routed along a complicatedly curved route in an inside of a vehicle. A wiring harness disclosed in Patent Document 1 includes: a plurality of electric wires having terminals at ends thereof, and a plurality of synthetic-resin-made protectors. The electric wires are received in and protected by various protectors of which shapes correspond to routing positions. The various protectors are protecting members for protecting the plurality of electric wires collectively, and formed in various shapes.

### PRIOR ART DOCUMENT

### Patent Document

Patent Document 1: JP, A, 2005-80380

### DISCLOSURE OF THE INVENTION

### Problem to be Solved by the Invention

In the conventional art described above, it is necessary to design a protector of which shape corresponds to the routing position. Therefore, the protector is designed with respect to every vehicle type, and there is a problem that the design man-hour is increased to increase the cost. Regarding the increase of the cost, the main factor is that the molding facility and the die used in molding the protector become extensive.

Accordingly, an object of the present invention is to provide a protector which does not need an extensive facility or an extensive die, and a wiring harness having the protector.

### Means for Solving the Problem

For attaining the object, according to the invention claimed in claim 1, there is provided a protector comprising base material holding water-curable resin composition which is hardened by water to be a specific shape including a conductive line receiving portion, or comprising base material holding light-curable resin composition which is hardened by light to be a specific shape including a conductive line receiving portion.

According to the invention claimed in claim 2, there is provided the protector as claimed in claim 1,

wherein an attaching face is formed in accordance with a receiving opening face of the conductive line receiving portion.

According to the invention claimed in claim 3, there is provided the protector as claimed in claim 2,

wherein a shielding member is integrally formed so as to surround the conductive line receiving portion.

According to the invention claimed in claim 4, there is provided a wiring harness comprising:

one or a plurality of conductive lines; and

the protector as claimed in any one of claims 1 to 3,

wherein the conductive lines are received in the conductive line receiving portion of the protector.

According to the present invention having the features described above, the protector is made by hardening the water-curable resin compound or light-curable resin compound held in the base material. The protector can be made in a facility for only hardening it having a simplified die, and can be formed and provided in a wiring harness production process. Further, according to the present invention, when the conductive line receiving portion of the protector receives the conductive line, a wiring harness protecting the conductive line is attained. The wiring harness can be attached via the protector, and routed in a desired route by the protector. In addition, it is also possible to prevent noise by including a shield member in a structure of the protector.

### Effects of the Invention

According to the invention claimed in claim 1, a protector which does not need an extensive facility or an extensive die can be provided. Thereby, the cost can be reduced.

According to the invention claimed in claim 2, the wiring harness can be attached via the protector. Further, the receiving opening face of the protector can be covered by only attaching the protector without a cover member for covering the receiving opening face of the conductive line receiving portion. Therefore, a new component is unnecessary to cover the receiving opening face, and the cost can be reduced.

According to the invention claimed in claim 3, the noise can be prevented by the protector itself.

According to the invention claimed in claim 4, a low-cost wiring harness can be provided.

### BRIEF DESCRIPTION OF DRAWINGS

FIG. 1 A schematic view showing a vehicle in which a wiring harness having a protector according to the present invention is routed.

FIG. 2A A perspective view showing a front side of the wiring harness having the protector.

FIG. 2B A perspective view showing a rear side of the wiring harness having the protector.

FIG. 3 A sectional view showing the wiring harness having the protector.

FIG. 4A A schematic view showing the protector.

FIG. 4B A partially sectional perspective view showing the protector and a simplified die used for producing the protector.

### DESCRIPTION OF EMBODIMENTS

A protector of a wiring harness for protecting conductive lines is made of water-curable or light-curable resin compound.

### Embodiment

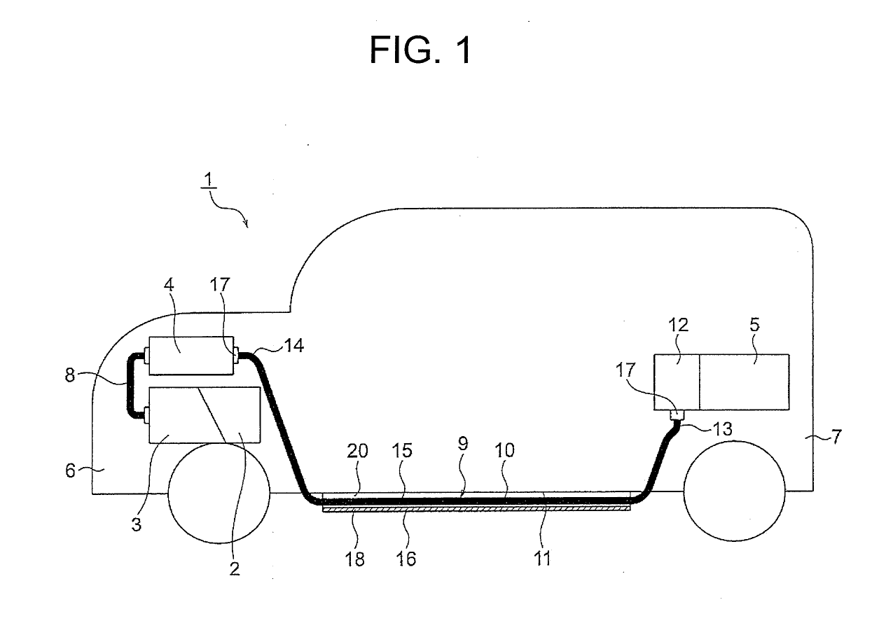

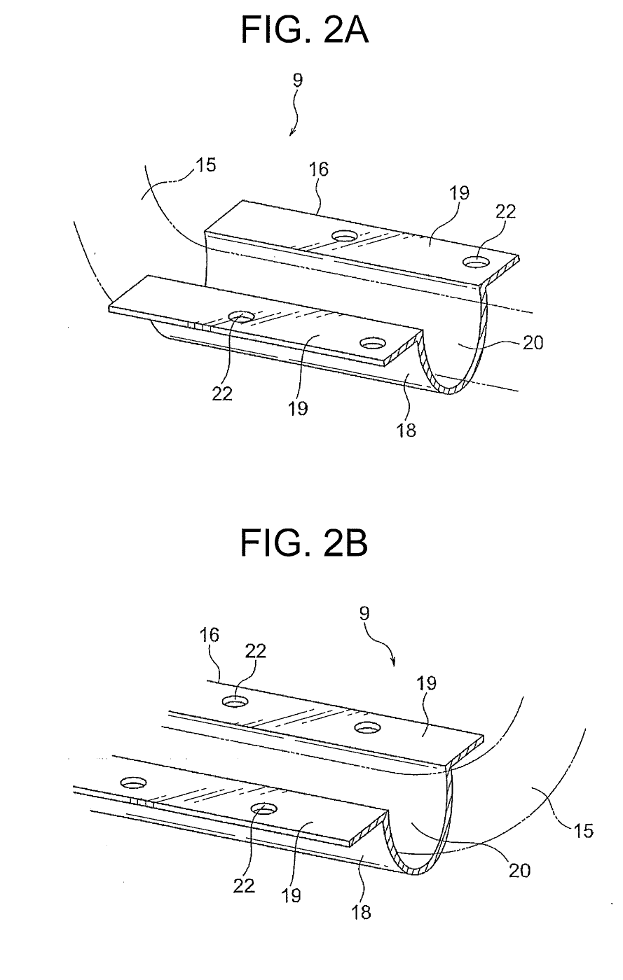

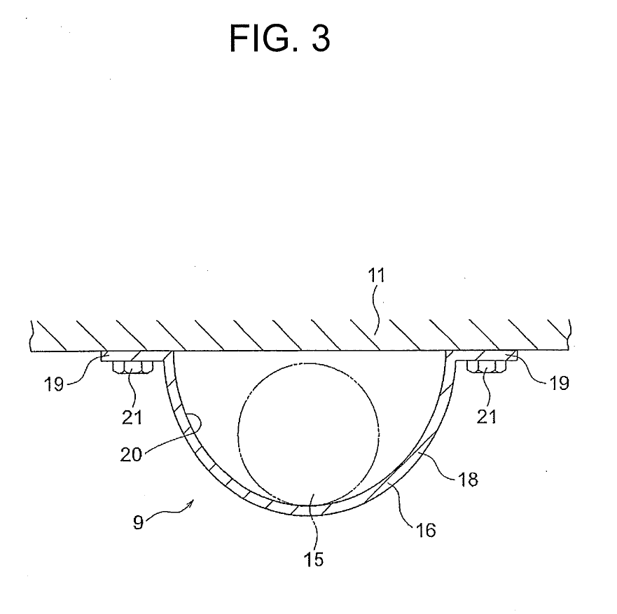

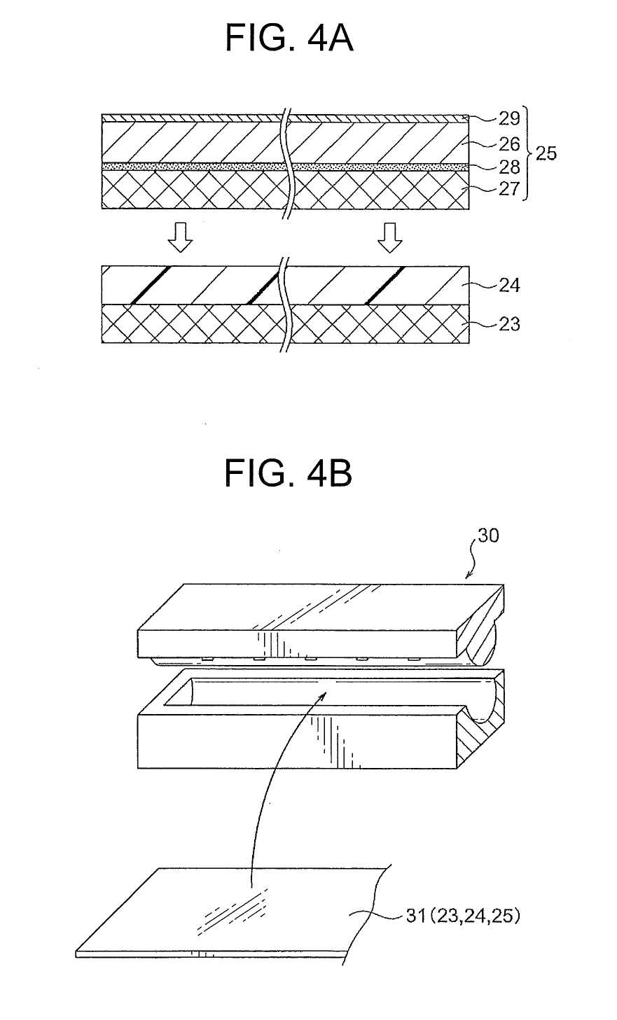

Hereinafter, an embodiment will be explained with reference to figures. FIG. 1 is a vehicle in which a wiring harness having a protector according to the present invention is routed. FIGS. 2A and 2B are a perspective view showing the wiring harness having the protector. FIG. 3 is a sectional view showing the wiring harness having the protector. FIG. 4A is a schematic view showing the protector. FIG. 4B is a view of a simplified die.

In this embodiment, a wiring harness according to the present invention is used in a hybrid vehicle (or an electric vehicle).

In FIG. 1, reference sign 1 denotes a hybrid vehicle. The hybrid vehicle 1 is driven by a mixture of an engine 2 and a motor unit 3. Electric power is supplied to the motor unit 3 via an inverter unit 4 from a battery 5 (battery pack). In this embodiment, the engine 2, the motor unit 3, and the inverter unit 4 are mounted on an engine room 6 where front wheels are provided. The battery 5 is mounted on a rear portion of the vehicle where rear wheels are provided (the battery 5 may be mounted on a vehicle cabin at a rear side of the engine room 6).

The motor unit 3 and the inverter unit 4 are connected to each other with a well-known high voltage wiring harness 8. The battery 5 and the inverter unit 4 are connected to each other with a wiring harness 9 of the present invention. The wiring harness 9 is a high voltage wiring harness. An intermediate portion 10 of the wiring harness 9 is routed at a ground side of a vehicle underfloor 11. The vehicle underfloor 11 is a well-known body and a so-called panel member. A through-hole (reference sign is omitted) is provided at a specific position of the vehicle underfloor 11.

The wiring harness 9 and the battery 5 are connected to each other with a junction block 12 mounted on the battery 5. A connector at a rear end 13 of the wiring harness 9 is connected to the junction block 12. The rear end 13 of the wiring harness 9 is routed over a floor at the vehicle cabin. A front end 14 of the wiring harness 9 is also routed over the floor. A connector at the front end 14 of the wiring harness 9 is connected to the inverter unit 4. The intermediate portion 10 of the wiring harness 9 is routed substantially parallel to the vehicle underfloor 11.

Here, a supplemental explanation of this embodiment will be carried out. The motor unit 3 includes: a motor; and a generator. Further, the inverter unit 4 includes: an inverter; and a convertor. The motor unit 3 is formed in a motor assembly having a shield case. The inverter unit 4 is also formed in an inverter assembly having a shield case. The battery 5 is Ni-MH or Li-ion, and formed in a module. Incidentally, a capacitor or the like can be used instead of the battery. The battery 5 is not particularly limited as long as it can be used in the hybrid vehicle 1 or the electric vehicle.

Hereinafter, a configuration and a structure of the wiring harness 9 will be explained.

The wiring harness 9 includes: one or a plurality of high voltage conductive lines 15 (conductive lines); and a half pipe 16 (protector) for protecting the high voltage conductive lines 15.

In this embodiment, high voltage electric wires are used as the high voltage conductive lines 15 (in addition, low voltage electric wires may be included in the conductive lines). Further, two high voltage conductive lines 15 are provided. The high voltage conductive lines 15 includes: a conductor; and an insulator (cover) and has a length enough for electrical connection. The conductor is made of copper, copper alloy, aluminum, aluminum alloy, or the like. The conductor may be made by stranding element wires, or formed in a rectangular or circular bar shape (in this case, the electric wire is also formed in a bar shape). The high voltage conductive lines 15 are not shielded wires. A connecting portion 17 such as a connector is provided at ends of the high voltage conductive lines 15.

Incidentally, in this embodiment, the high voltage electric wires are used as the high voltage conductive lines 15. However, the present invention is not limited to this. Namely, a well-known bus bar with the insulator may be used. As described above, because the high voltage conductive lines 15 are not the shielded wires in this embodiment, the half pipe 16 has the shielding function (If the high voltage conductive lines 15 are the shielded wires, the half pipe 16 will not have the shielding function).

In FIGS. 1 to 3, the half pipe 16 is a protective member, and made by hardening water-curable resin compound 24 (or light-curable resin compound) in a specific shape held by later-described base material 23. In this embodiment, for protecting a portion of the high voltage conductive lines 15 routed on the vehicle underfloor 11, the half pipe 16 is formed in a long shape. Incidentally, the half pipe 16 may protect portions of the high voltage conductive lines 15 other than the vehicle underfloor 11. Namely, the half pipe 16 may protect curved portions of the high voltage conductive lines 15 and hold the shapes of the high voltage conductive lines 15.

In this embodiment, the half pipe 16 includes: a main body portion 18 having half of a circular pipe shape; and an attaching portion 19 continued to the main body portion 18. The shape of the half pipe 16 is not limited to this. The half pipe 16 may be formed in a straight pipe shape, or a curved pipe shape.

The main body portion 18 includes a conductive line receiving portion 20 for receiving the high voltage conductive lines 15. Both ends in a longitudinal direction of the conductive line receiving portion 20 are opened, and a face opposite to the vehicle underfloor 11 (receiving opening face) is also opened. The main body portion 18 is formed corresponding to a routing route of the high voltage conductive lines 15 such as extending straight.

The attaching portion 19 includes an attaching face arranged in the same plane as the receiving opening face of the conductive line receiving portion 20. In this embodiment, the attaching portion 19 is formed in a substantially flange shape (for example, the attaching portion 19 may formed in reeds shape projecting corresponding to a fixing positions). The attaching portion 19 includes a plurality of bolt-insertion holes 22 for fixing with such as bolts 21.

When the half pipe 16 is attached and fixed to the vehicle underfloor 11, as shown in FIG. 3, the half pipe 16 covers around and protects the high voltage conductive lines 15. Incidentally, in an attaching condition shown in FIG. 3, noise is effectively prevented by installing the shielding function on the half pipe 16. (It is an option to install the shielding function on the half pipe 16. A configuration of the shielding function will be described later.)

As shown in FIG. 4A, the half pipe 16 includes: base material 23; and water-curable resin compound 24 (or light-curable resin compound) held in the base material 23. Further, in this embodiment, for installing the shielding function, a shielding member 25 is also included (it is an option to include the shielding member 25).

The water-curable resin compound 24 is hardened by such as injection, dripping of liquid material, or dipping in the water, and held in the base material 23 by impregnation or the like. As the base material 23, glass wool, glass cloth, polyester cloth, non-woven fabric cloth, or the like can be used. (These are not limited to the water-curable resin compound 24, and also applicable to the light-curable resin compound. Incidentally, regarding the glass cloth and the polyester cloth, knitted fabric is suitable for impregnation, and has a merit to be impregnated evenly and uniformly.) Further, as the water-curable resin compound 24, water-curable urethane resin can be used. Preferably, curing time of the water-curable resin compound 24 is adjustable such as rapid curing or slow curing (for example, about five to ten minutes).

Regarding the water-curable resin compound 24, when the water-curable resin compound 24 is held in the base material 23 by impregnation, the used amount of the water-curable resin compound 24 can be reduced.

In contrast, light-curable resin compound is hardened by visible light or exclusive illumination, and held in the base material by impregnation or the like. In this embodiment, the curing time of the light-curable resin compound is adjustable similar to the water-curable resin compound 24. Regarding the light-curable resin compound, when the light-curable resin compound is held in the base material by impregnation, the used amount of the light-curable resin compound can be reduced similar to the water-curable resin compound. In addition, the light-curable resin compound can be used in a water-free environment.

The water-curable resin compound 24 (or the light-curable resin compound) and the base material 23 are formed in a desired thickness. Alternatively, they are formed in a desired thickness by overlapping a plurality of layers thereof. Thereby, they secure strength and maintain the route. Further, because they secure strength, they are protected against jumping stones or the like.

A size of the shielding member 25 corresponds to a range where the electric shield is needed. In this embodiment, the shielding member 25 is the same size as the water-curable resin compound 24 (or the light-curable resin compound) held in the base material 23.

The shielding member 25 includes: a metal foil 26; a sheet-shaped base material layer 27; a joining layer 28 for joining these; and a plated layer 29. When arranging them sequentially from a side nearest the high voltage conductive lines 15, they are the plated layer 29, the metal foil 26, the joining layer 28, and the base material layer 27.

The plated layer 29 is made by plating tin and having a specific thickness (for example, about 0.8 micrometer). The plated layer 29 is on the metal foil 26 for the purpose of holding environment resistance (anti-rust treatment). Incidentally, the plated layer is not limited to the tin plating as long as it has conductivity, further, it is an option to set the plated layer 29. In this embodiment, the metal foil 26 made of copper foil is used. For this reason, the tin plating is provided in consideration of the environment.

The metal foil 26 is made of conductive metal such as copper, copper alloy, aluminum, aluminum alloy, or iron, and has a specific thickness (for example, about 35 micrometers) for performing electromagnetic shield. The metal foil 26 is connected to a shield case of the inverter unit 4 or the junction block 12 via the connecting portion 17. Incidentally, a drain line for abutting on the metal foil 26 may be provided.

A conductive cloth or a braided wire can be used instead of the metal foil 26.

The joining layer 28 is provided for joining the metal foil 26 and the base material layer 27. In this embodiment, a well-known adhesive is used as the joining layer 28, but the present invention is not limited to this.

The base material layer 27 is a base for the shielding member 25 and has a specific thickness (for example, about 25 micrometers). In this embodiment, a size of the base material layer 27 is the same as the metal foil 26. The material of the base material layer 27 can be properly selected corresponding to a type of usage of the wiring harness 9, and for example, PET sheet made of polyethylene terephthalate, polyester sheet, acetate cloth, polyester cloth, glass cloth, nonwoven cloth, insulating paper, PET cloth, or the like can be used. A large peeling strength of the shielding member 25 can be attained when the water-curable resin compound 24 (or the light-curable resin compound) sinks into the base material layer 27 made of glass cloth, nonwoven cloth, or the like. Incidentally, by using adhesive force of the water-curable resin compound 24 (or the light-curable resin compound), the metal foil 26 may be directly fixed (in this case, the base material layer 27 is omitted).

Regarding the formation of the half pipe 16, a supply device for supplying water or light for hardening the water-curable resin compound 24 (or the light-curable resin compound) is installed in a wiring harness manufacturing scene or a wiring harness routing scene. The water-curable resin compound 24 (or the light-curable resin compound) held in the base material 23 and the shielding member 25 are simultaneously pressed by a simplified die 30 (see FIG. 4B) installed together with the supply device. Thus, the half pipe 16 is formed by this simultaneous press. The formed half pipe 16 has rigidity because the water-curable resin compound 24 (or the light-curable resin compound) is hardened, and can be handled and assembled similar to a well-known protector. In FIG. 4B, reference sign 31 schematically denotes the water-curable resin compound 24 (or the light-curable resin compound) held in the base material 23 and the shielding member 25.

In this embodiment, a long half pipe 16 is made by one press. However, the present invention is not limited to this. Namely, the long half pipe 16 may be made by overlapping ends of short half pipes to each other, and by pressing the overlapped portions to be connected to each other.

As explained with reference to FIGS. 1 to 4B, according to the present invention, a half pipe 16 working as a protector is made by hardening water-curable resin composition 24 (or light-curable resin compound) held in base material 33. The half pipe 16 can be made in a facility for only hardening it having a simplified the 30, and can be formed and provided in a wiring harness production process, namely, can be formed and provided corresponding to a vehicle requirement. Further, according to the present invention, the wiring harness 9 for protecting a specific portion of the high voltage conductive lines 15 is made by receiving the high voltage conductive lines 15 in the conductive line receiving portion 20 of the half pipe 16. The wiring harness 9 may be attached via the half pipe 16, and routed in a desired route with the half pipe 16. In addition, the wiring harness 9 can be protected from noise because the half pipe 16 includes the shielding member 25.

Of course, various embodiments can be practiced within a scope of the present invention.

In the explanation above, the wiring harness 9 is routed in the hybrid vehicle 1. However, the present invention is not limited to this. A common vehicle can be used. Further, in the embodiments, the wiring harness 9 is the high voltage wiring harness. However, the present invention is not limited to this. A low voltage wiring harness can be used. Further, the half pipe 16 is explained as one embodiment of the present invention. However, the present invention is not limited to this. a shape of the protector is not particularly limited as long as it can be used instead of the conventional protector.

### REFERENCE SIGNS LIST

1 hybrid vehicle
2 engine
3 motor unit
4 inverter unit
5 battery
6 engine room
7 rear portion of a vehicle
8 high voltage wiring harness
9 wiring harness
10 intermediate portion
11 underfloor of a vehicle body
12 junction block
13 rear end
14 front end
15 high voltage conductive line (conductive line)
16 half pipe (protector)
17 connecting portion
18 main body portion
19 attaching portion
20 conductive line receiving portion
21 bolt
22 bolt-insertion hole
23 base material
24 water-curable resin composition (or light-curable resin composition)
25 shielding member
26 metal foil
27 base material layer
28 joining layer
29 plated layer
30 simplified die

1. A protector comprising base material holding water-curable resin composition which is hardened by water to be a specific shape including a conductive line receiving portion, or comprising base material holding light-curable resin composition which is hardened by light to be a specific shape including a conductive line receiving portion.

2. The protector as claimed in claim 1,
wherein an attaching face is formed in accordance with a receiving opening face of the conductive line receiving portion.

3. The protector as claimed in claim 2,
wherein a shielding member is integrally formed so as to surround the conductive line receiving portion.

4. A wiring harness comprising:
one or a plurality of conductive lines; and
the protector as claimed in claim 1,
wherein the conductive lines are received in the conductive line receiving portion of the protector.

5. A wiring harness comprising:
one or a plurality of conductive lines; and
the protector as claimed in claim 2,
wherein the conductive lines are received in the conductive line receiving portion of the protector.

6. A wiring harness comprising:
one or a plurality of conductive lines; and
the protector as claimed in claim 3,
wherein the conductive lines are received in the conductive line receiving portion of the protector.
